(19) United States
(12) Patent Application Publication
(10) Pub. No.: US 2007/0129886 A1
(43) Pub. Date: Jun. 7, 2007

(54) Method for traffic-only access using integrated satellite radio data and navigation system

(76) Inventors: Mona L. Toms, Carmel, IN (US); Andres E. Avila, Kokomo, IN (US)

Correspondence Address: DELPHI TECHNOLOGIES, INC., M/C 480-410-202, PO BOX 5052, TROY, MI, 48007, US

(21) Appl. No.: 11/295,287

(22) Filed: Dec. 6, 2005

(51) Int. Cl. G01C 21/34

(52) U.S. Cl. 701/210; 701/209; 340/995.13; 340/995.21

(57) ABSTRACT

A method and system for presenting traffic-only information to a vehicle user. One embodiment of the method and system includes offering a traffic-only mode of operation to the user and receiving at least one of a starting point, a destination point, or a route between a starting point and a destination point. Information relating to the position of the vehicle and relating to traffic information relative to the vehicle's position is accessed and at least some of the traffic information is communicated to the vehicle user without communicating route guidance information to the vehicle user.

### TECHNICAL FIELD

This invention generally relates to navigation systems and more particularly relates to navigation systems that incorporate current traffic information.

### BACKGROUND OF THE INVENTION

Satellite radio services can be integrated with a vehicle's on-board navigation system to provide current traffic information relating to a route of travel. For example, NavTraffic™ is an XM satellite data service that is combined with NAVTEQ digital map data and used by a vehicle on-board navigation system. XM NavTraffic™ is a standard feature on select 2005 vehicles. Although current navigation systems do offer traffic information, such systems are only valuable if the human interface they provide is easy to use and desired tasks are quickly accomplished. Current system interfaces for accessing traffic information are overly complex, especially for routes of traffic that are frequently used (e.g. a work route). For frequent routes of travel, the user may only want traffic information and not route guidance inasmuch as the route of travel is well known. However, in current systems, route creation and guidance are packaged together such that a route must be created (or selected if previously stored) in order to access traffic information associated with the known route. Specifically, in many systems currently available, the user must first create and store a route, and then either 1) display the “route map with traffic icons” or 2) access a traffic event page that lists all traffic events along the given route. This process is cumbersome and time consuming for those users that only need current traffic information along a well-known route of travel.

A simplified system is needed for those users who merely desire traffic information for frequent travel routes, such as a route to work.

### BRIEF DESCRIPTION OF THE DRAWINGS

FIG. 1 is a schematic drawing showing a system which implements an embodiment of the present invention;

FIG. 2A is a logic flow diagram setting forth one methodology for inputting a starting point, and a destination point embodiment of the present invention;

FIG. 2B is a first embodiment of the methodology of the present invention;

FIG. 3 is a second embodiment of the methodology of the present invention;

FIG. 4 is a logic flow diagram of an embodiment of the multiple route embodiment of the present invention.

### DETAILED DESCRIPTION OF THE INVENTION

The present invention can be implemented using a receiver/information processor 10 located within a vehicle 12. The receiver/information processor 10 is effective for receiving traffic information 14, positional information 16 and carrying out navigation functions. Traffic information 14 is made available to receiver/information processor 10 from a traffic information data source 18. One such commercially available traffic information data source 18 is NavTraffic™ which is a traffic data service currently made available via the XM satellite data network. Although NavTraffic™ is one source of traffic information, it is contemplated that the present invention can be implemented using any number of traffic information sources currently available or those that will be made available in the future.

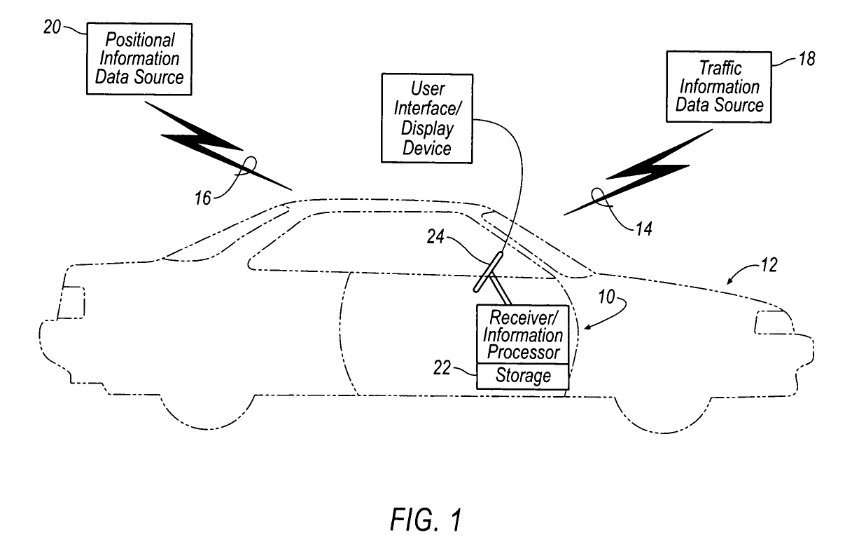

Positional information 16 is made available by way of any number of positional information data sources 20. One such positional information data source 20 is the satellite network known as the Global Positioning System controlled by the U.S. Department of Defense (hereinafter GPS system). Although the GPS system is one network that will provide positional information, it is contemplated that any system that is capable of providing positional information to vehicle 12 is sufficient for satisfying the requirements of positional information data source 20. Additionally, traffic information data source 18 and positional information data source 20 are shown as two separate sources in FIG. 1; however, this is depicted in this manner in order to simplify the concepts presented herein and it is fully contemplated that it is possible for a single source to provide both the traffic information 14 and the positional information 16 required to use the present invention.

Receiver/information processor 10 is designed to receive traffic information 14 and positional information 16 and to synthesize that information in the manner discussed herein. Receiver/information processor 10 also may include storage 22 for storing, amongst other information, frequently used routing information. Receiver/information processor 10 is coupled to user interface display device 24 which provides the primary mode of interfacing with the user. It is contemplated that user interface/display device 24 includes both means of outputting information to a user and means of accepting information from a user and transferring that information to receiver/information processor 10.

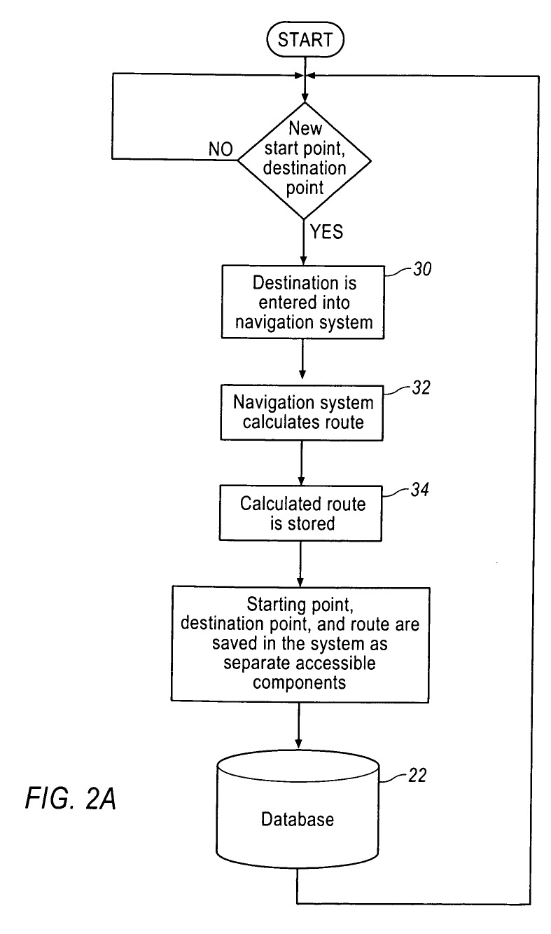

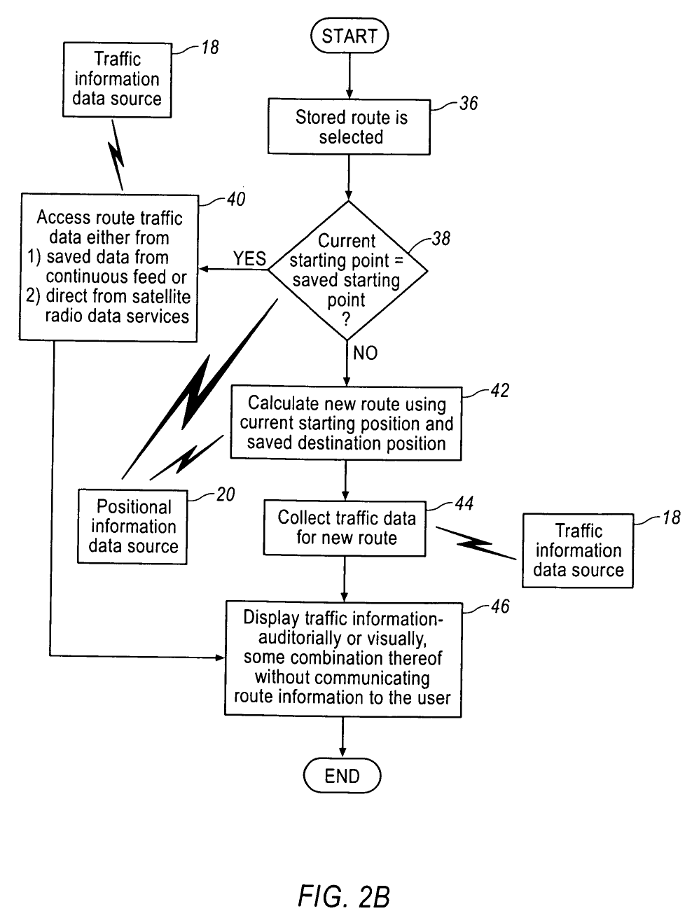

Now referring to FIG. 1 and FIG. 2A, one embodiment of the current method for providing easily accessed, traffic-only information to a user is to first allow the user to input one or more destination locations. These destination addresses can be formatted in any number of formats including the name of a city, the name of a commercial establishment, the intersection of two major crossroads, a mailing address, a zip code, tourist attractions, or some combination of the above. Starting points may also be inputted by the user in step 30 and starting points can be formatted in any likewise manner described above. In addition to the destination location and the starting location, a route associated therebetween is initially created 32 and stored 34. Any number of stored routes can be saved 34. It is also contemplated that a user can assign stored routes easily remembered names such as “Dad's route to work” or “Mom's route to work.” Starting point, destination point, and routes therebetween are easily saved in non-volatile memory 22 which may be structured as a database.

When a user is ready to access the system using the traffic-only mode of operation, first, the user selects a route of interest 36 (see FIG. 2B). This selection 36 can be made audibly (such as the user stating “Dad's route to work”) or can be selected by the user by accessing a stored list of routes by way of device 24. The stored list of routes can be organized in any number of convenient formats such as alphabetical by location, frequency of use, most recently used, and the like. After the user has selected a route of interest 36, the system would confirm that the current starting position of the vehicle is generally within the predetermined ranged of the saved starting position. The saved starting position is available on database 22 and the current position of the vehicle is discernable using positional information data source 20. If the current starting position of the vehicle is the same, or generally the same, as the saved starting point 38 (for the selected route), the method progresses to step 40 wherein the current traffic data is accessed (using traffic information data service 18) either from 1) recently saved traffic information data or 2) direct from traffic information data source 18. Ideally, traffic information 14 from traffic information data source 18 would be on a continuous feed (working in the background). However, there are circumstances wherein real-time traffic information may not be available and the system may be limited to working with the most recently available traffic information which has been downloaded and stored on storage device 22.

If the starting position differs from the stored starting position 38, a new route is created 42. New route 42 is created by routing a path from the current vehicle position to the saved destination. The route calculation performed in step 42 would generally be transparent to the user and temporary (unless the user overrides the temporary route and makes it the default route for all future purposes). Once the new route has been calculated 42, the embodiment of FIG. 2B collects traffic information for the new route 44 and then presents traffic information to the user either audibly or visually (or some combination of the two) without communicating route information to the user.

This invention contemplates the use of satellite event data and location code data currently made available by commercial services. The satellite event and location code data cover a broad spectrum of possible traffic incidents and hazardous conditions and currently employ over 3,100 agreed-upon event codes in the European RDS-TMC protocol. The location codes are effective for pinpointing the location of traffic incidents while the event codes are effective for standardizing the definition of the nature of the incidents. When the event and location code data reaches receiver/information processor 10 it can be easily decoded and presented to the user in any number of convenient formats (including audibly).

The starting point and destination point information relevant to a route can be input by the user in any number of formats (voice, touch screen, cursor control, hard or soft reconfigurable preset buttons, or the like). Any one of these control methodologies will allow the user to scroll through a stored route list to select a predefined route. The interface could also consist of an audio output such as text-to-speech (TTS) although audio output is not a requirement of this invention. The current traffic data could be announced (audibly) or displayed graphically (text or via a map) for predetermined traffic options.

Thus, in its simplest embodiment, the present invention employs a simple interface for allowing a user to access traffic-only information for a programmed route (particularly for a programmed route which is frequently traveled). For example, using the present invention, the user can access the current invention by simply stating “Dad's route to work” wherein the system will access the predetermined route to work for “Dad” and, based on that route, the user will be presented with current traffic information for the user. Thus, it is conceivable with the present invention that the user may only input one command (e.g. “Dad's route to work”) and thereafter be presented with timely traffic information. There is no system that offers this extreme ease of use.

The embodiment of the present invention as it has been presented contemplates that one route will be defined between a starting point and a destination point. In a second embodiment (hereinafter “alternate route embodiment”), two or more alternative routes are offered to the user for selection.

### ALTERNATIVE ROUTE EMBODIMENT

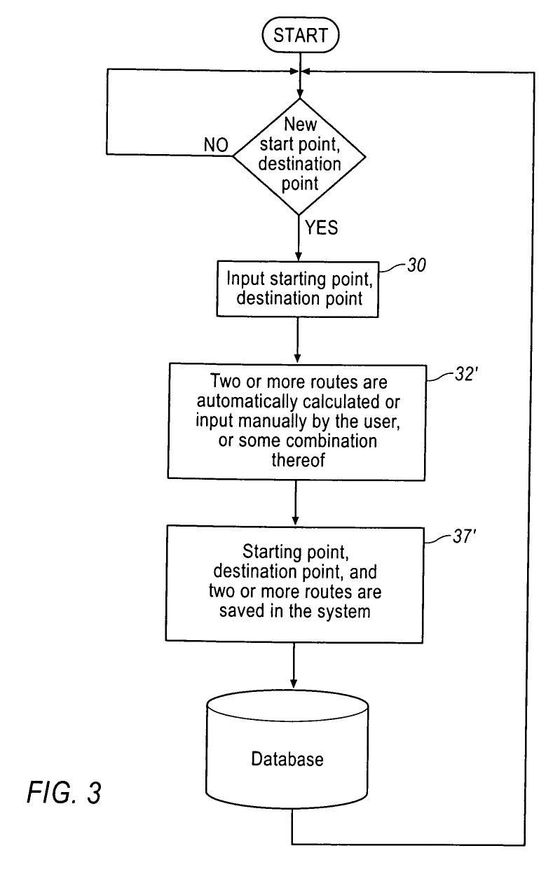

Now referring to FIG. 3, the methodology of the embodiment of FIG. 3 closely tracks the methodology set forth in FIG. 2B; however, instead of calculating a single route (as seen in step 32 of FIG. 2A), in the current embodiment, two or more routes are automatically calculated, input manually by the user, or some combination thereof 32′. By creating a plurality of routes to a common destination and saving these routes 37′ with a common identifier label (e.g. “Dad's routes to work”), the user can select from a plurality of routes to a given destination. Two or more routes can be created using any number of techniques, some of which are:

1. allowing a user access to a route editing tool which allows inclusion of certain roads and exclusion of other roads;

2. allowing a user to create waypoints along one or more routes to a given destination. Thereafter, any number of automatic routing techniques can be used to construct one or more routes using the mandatory waypoints;

3. allowing a user to initiate “breadcrumb” route data (derived from GPS data used to track vehicle position during the creation of a route). “Breadcrumb data” is created by periodically saving GPS coordinates of a vehicle during a vehicle's travel. In order to use the “breadcrumb” route generation, the user vehicle is first required to travel an intended route so that the “breadcrumb” data points can be generated and saved.

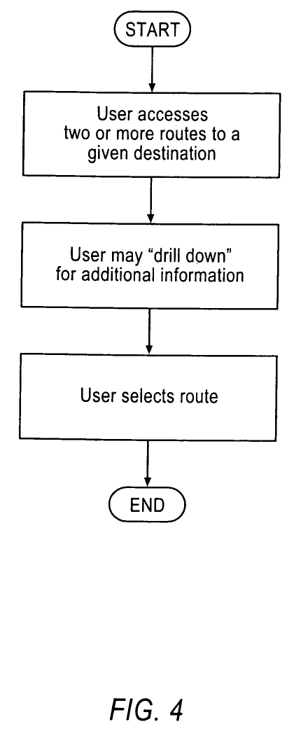

Once two or more routes have been either automatically, manually, or some combination thereof, calculated 32′ and stored 37′, the user may use this route information for accessing traffic data associated with the two or more routes. For example (see FIG. 4), in one embodiment the user may issue a voice command, such as “traffic Dad's route to work—Route One” to which the system could respond: “estimated travel time 35 minutes—accident at Keystone and I-31.” If the user knows that 35 minutes is an unusually long period of time to traverse Route One, the user may say: “traffic all routes to Dad's office” to which the system would then provide information on the two or more routes that are stored in the system for “Dad's route to the office.” The system may respond something like the following:

“Route One: Estimated travel time 30 minutes”

“Route Two: Estimated travel time 43 minutes”

“Route Three: Estimated travel time 51 minutes”

Based on the above, the user would probably select the route (Route One in this example) associated with the shortest travel time. An optional feature includes offering more detailed information (known as “drill down” information) to the user. For example, if the user knows that 35 minutes is an excessive amount of time to traverse Route One, the user may say “Details—Route One”, wherein the system could respond with detailed traffic information associated with Route One such as “Accident at Keystone and I-31—overturned tractor trailer.”

Hard or soft controls in the form of a preset or route listing from which the user could select alternate routes can be made available to the user by way of user interface display device 24 (see FIG. 1). Additionally, audio commands can be issued by the user to control processor 10. Audio commands from the user to receiver/information processor 10 can be implemented using TTS or the like similar to that which would be used in a voice recognition system. Additionally, estimated time and other details communicated to the user can be sent audibly or displayed in a graphic user interface (GUI).

Having described the embodiments of the present invention, it will be understood that various modifications or additions may be made to the embodiments chosen here to illustrate the present invention, without departing from the spirit of the present invention. Accordingly, it is to be understood that subject matter sought to be afforded protected hereby shall be deemed to extend to the subject matter defined in the appended claims, including all fair equivalents thereof.

What is claimed as new and desired to be protected by Letters Patent of the United States is:

1. A method for presenting traffic-only information to a vehicle user, comprising the steps of:
A) offering a traffic-only mode of operation for selection by the user,
B) receiving at least one of a starting point, a destination point, or a route between a starting point and a destination point,
C) accessing position information relating to the vehicle's position,
D) accessing traffic information relative to the vehicle's position,
E) communicating to said vehicle user at least some of said traffic information accessed in step D), without communicating route guidance information to said vehicle user.

2. The method of claim 1, wherein said position information is accessed from a first source and said traffic information is accessed from a second source.

3. The method of claim 1, wherein said position information and said traffic information are accessed from one or more common transmission sources.

4. The method of claim 1, wherein step B) includes the substep of
recalling a destination point from a plurality of stored destination points.

5. The method of claim 1, wherein step C) includes the substep of:
accessing position information from a Global Positioning System comprised of a plurality of satellite.

6. The method of claim 1, wherein step D) includes the substep of:
accessing traffic information from a satellite radio service provider.

7. The method of claim 1, wherein a current position of said vehicle is compared to said at least one starting point.

8. The method of claim 1, wherein communicating to said vehicle user included audibly communicating with said vehicle user.

9. The method of claim 1, wherein step B) further includes the step of receiving a plurality of routes between a starting point and a destination point.

10. The method of claim 9, wherein each route in said plurality of routes includes detailed information, wherein said plurality of routes is made manifest to the vehicle user in a format that permits the vehicle user to drill down into one or more routes to reveal said detailed information.

11. The method of claim 1, wherein step B) includes allowing the user to access a route editing tool to create a route which allows the inclusion of a first plurality of roads and the exclusion of a second plurality of roads.

12. The method of claim 1, wherein step B) includes allowing the user to create a route that includes waypoints along the created route.

13. The method of claim 1, wherein step B) includes allowing the user to create a breadcrumb route by storing route coordinates traversed by the vehicle as the vehicle travels.

14. A system for presenting traffic-only information to a vehicle user, comprising:
a receiver/information processor unit having a traffic-only mode of operation, wherein said receiver/information processor is adapted to receive information relating to at least one of a starting point, a destination point, or a route between a starting point and a destination point, wherein said receiver/information processor is adapted to access position data associated with the vehicle's position and traffic data relative to the vehicle's position, and wherein said receiver/information processor communicates to said vehicle user at least some of said traffic data without communicating route guidance information to said vehicle user.

15. The system of claim 14, wherein said vehicle position data is accessed from a first source and said traffic data is accessed from a second source.

16. The system of claim 14, wherein said vehicle position data and said traffic data are received from one or more common transmission sources.

17. The system of claim 14, wherein said receiver/information processor further includes means for calculating a route if a current position of said vehicle does not substantially match said at least one starting point.

18. The system of claim 14, wherein said receiver/information processor is adapted to receive a plurality of routes between said at least one starting point and said at least one destination point.

19. The system of claim 14, wherein said receiver/information processor is adapted to enable the user to create waypoints along the route.

20. The system of claim 14, wherein said receiver/information processor is adapted to enable the user to create a breadcrumb route wherein said receiver/information processor stores route coordinates of the vehicle as the vehicle travels.
